(19) United States
(12) Patent Application Publication
(10) Pub. No.: US 2014/0055503 A1
(43) Pub. Date: Feb. 27, 2014

(54) DISPLAY APPARATUS

(71) Applicant: Samsung Display Co., Ltd., Yongin-City (KR)

(72) Inventors: MEEHYE JUNG, Suwon-si (KR); Sang-Uk LIM, Yongin-si (KR); JaeSung BAE, Suwon-si (KR); BONGHYUN YOU, Yongin-si (KR)

(21) Appl. No.: 13/911,933

(22) Filed: Jun. 6, 2013

(30) Foreign Application Priority Data
Aug. 21, 2012 (KR) 10-2012-0091490

(51) Int. Cl. G09G 5/10; G09G 3/36

(52) U.S. Cl. CPC G09G 5/10; G09G 3/3607
USPC 345/690; 345/89

(57) ABSTRACT

A display apparatus includes a plurality of pixels, each of the pixels including a high pixel and a low pixel, a first data driver disposed on a first side of the display panel and applying first data voltages to the high pixels through first data lines, a second data driver disposed on a second side opposite the first side of the display panel and applying second data voltages to the low pixels through second data lines, and a first gate driver formed on a third side of the display panel between the first side and the second side, and sequentially applying gate signals to the plurality of pixels connected to gate lines. The first data voltages are sequentially supplied to the high pixels from the first side of the display panel and the second data voltages are sequentially supplied to the low pixels from the second side of the display.

### CROSS-REFERENCE TO RELATED APPLICATION

This U.S. non-provisional patent application claims priority under 35 U.S.C. §119 of Korean Patent Application No. 10-2012-0091490, filed on Aug. 21, 2012, the contents of which are hereby incorporated by reference.

### BACKGROUND

1. Field of disclosure

The present disclosure relates to a display apparatus. More particularly, the present disclosure relates to a display apparatus capable of reducing brightness difference.

2. Description of the Related Art

In recent years, various display devices, such as a liquid crystal display, an organic light emitting diode display, an electrowetting display device, an electrophoretic display device, etc., have been developed.

In general, the display device includes pixels to display an image. The pixels receive gate signals through gate lines. The pixels receive data signals through data lines in response to the gate signals and display gray scales corresponding to the data signals.

Among the display devices, the liquid crystal display has a viewing angle inferior to that of the other display devices. To improve the viewing angle of the liquid crystal display, various driving modes for the liquid crystal display, e.g., a patterned vertical alignment (PVA) mode, a multi-domain vertical alignment (MVA) mode, a super-patterned vertical alignment (S-PVA) mode, etc., have been suggested.

In the S-PVA mode liquid crystal display, each pixel includes two sub-pixels applied with different data voltages from each other. Human's eyes perceive an intermediate gray value between the two data voltages. Accordingly, deterioration in visibility due to distortion of a gamma curve at grayscale levels lower than the intermediate gray scale level can be prevented. As a result, a side visibility of the liquid crystal display is improved.

### SUMMARY

The present disclosure provides a display apparatus capable of reducing brightness difference.

Embodiments of the inventive concept provide a display apparatus includes a display panel that includes a plurality of pixels arranged in a matrix form, each of the plurality of pixels including a high pixel and a low pixel having a gray level lower than that of the high pixel, a first data driver disposed on a first side of the display panel and applying first data voltages to the high pixels through first data lines, a second data driver disposed on a second side opposite to the first side of the display panel and applying second data voltages to the low pixels through second data lines, and a first gate driver formed on a third side of the display panel between the first side and the second side, and sequentially applying gate signals to the plurality of pixels connected to gate lines. The first data voltages are sequentially supplied to the high pixels from the first side of the display panel and the second data voltages are sequentially supplied to the low pixels from the second side of the display panel opposite to the first side.

Each of the pixels receives a common voltage, the first data voltage has the level corresponding to a first difference value defined by an absolute value of a level difference between the first data voltage and the common voltage and the second data voltage has the level corresponding to a second difference value defined by an absolute value of a level difference between the second data voltage and the common voltage.

The first difference value is greater than the second difference value.

The high pixel is charged with a first pixel voltage corresponding to the first difference value and the low pixel is charged with a second pixel voltage corresponding to the second difference value.

The high pixel includes a first transistor connected to the corresponding gate line and the corresponding first data line and a first liquid crystal capacitor connected to the first transistor. The first transistor applies the corresponding first data voltage provided through the corresponding first data line to the first liquid crystal capacitor in response to the corresponding gate signal provided through the corresponding gate line.

The low pixel includes a second transistor connected to the corresponding gate line and the corresponding second data line and a second liquid crystal capacitor connected to the second transistor. The second transistor applies the corresponding second data voltage provided through the corresponding second data line to the second liquid crystal capacitor in response to the corresponding gate signal provided through the corresponding gate line.

Each of the first data voltage and the second data voltage has a positive or negative polarity.

The high pixel and the low pixel of any one of the pixels are applied with the first data voltage having the positive polarity and the second data voltage having the positive polarity, respectively.

The high pixel and the low pixel of another one of the pixels are applied with the first data voltage having the negative polarity and the second data voltage having the negative polarity, respectively.

The first and second data voltages having the positive polarity and the first and second data voltages having the negative polarity are alternately applied to the pixels in a column direction.

The first and second data voltages having the positive polarity and the first and second data voltages having the negative polarity are alternately applied to the pixels in a column direction and a row direction.

The high pixel and the low pixel are applied with the first and second data voltages having different polarities from each other.

The high pixel of any one of the pixels receives the first data voltage having the positive polarity and the low pixel of the any one of the pixels receives the second data voltage having the negative polarity.

The high pixel of another one of the pixels receives the first data voltage having the negative polarity and the low pixel of another one of the pixels receives the second data voltage having the positive polarity.

The first data voltage having the positive polarity and the first data voltage having the negative polarity are alternately and repeatedly applied to the first sub-pixels of the pixels at every row, and the second data voltage having the negative polarity and the second data voltage having the positive polarity are alternately and repeatedly applied to the second sub-pixels of the pixels at every row.

The first data driver is located at a position adjacent to an upper portion of the display panel and the second data driver is located at a position adjacent to a lower portion of the display panel.

The display apparatus further includes the second gate driver formed on a fourth side opposite to the third side of the display panel and sequentially applying the gate signals to the plurality of pixels connected to the gate lines.

The first and second gate drivers are respectively mounted on left and right sides in an amorphous silicon TFT gate driver circuit (ASG).

According to the above, the display apparatus reduces the brightness difference between the pixels, thereby preventing a vertical line from being perceived.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing a display apparatus according to an exemplary embodiment of the present invention;

FIG. 2 is a view showing pixels arranged in arbitrary one column among pixels shown in FIG. 1;

FIG. 3 is an equivalent circuit diagram showing arbitrary one pixel shown in FIG. 1;

FIG. 4A is a view showing charging voltages at a first pixel among pixels arranged in an arbitrary column shown FIG. 2;

FIG. 4B is a view showing charging voltages at a last pixel among pixels arranged in an arbitrary column shown FIG. 2;

FIGS. 5 to 8 are waveform diagrams showing polarities of first and second data voltages applied to the pixel shown in FIG. 3;

FIG. 9 is a view showing driving states of pixels; and

FIG. 10 is a view showing driving states of sub-pixels.

### DETAILED DESCRIPTION

Hereinafter, embodiments of the present invention will be explained in detail with reference to the accompanying drawings.

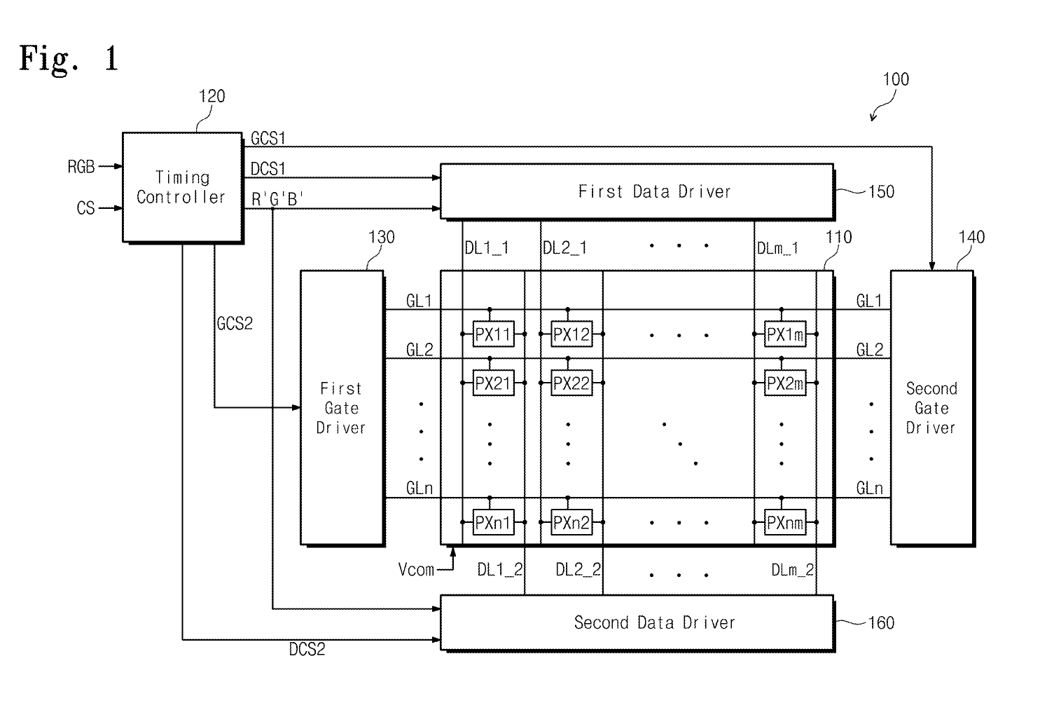

FIG. 1 is a block diagram showing a display apparatus according to an exemplary embodiment of the present invention.

Referring to FIG. 1, a display apparatus 100 includes a display panel 110, a timing controller 120, a first gate driver 130, a second gate driver 140, a first data driver 150, and a second data driver 160.

The display panel 110 includes a plurality of pixels PX11 to PXnm arranged in a matrix form, a plurality of gate lines GL1 to GLn each connected to pixels arranged in a corresponding row, and a plurality of data lines DL1_{—}1, DL1_{—}2, DL2_{—}1, DL2_{—}2, . . . , DLm-1, and DLm_{—}2 each connected to the pixels arranged in a corresponding column. The data lines DL1_{—}1, DL1_{—}2, DL2_{—}1, DL2_{—}2, . . . , DLm-1, and DLm_{—}2 cross the gate lines GL1 to GLn.

The data lines DL1_{—}1, DL1_{—}2, DL2_{—}1, DL2_{—}2, . . . , DLm-1, and DLm_{—}2 include a plurality of first data lines DL1_{—}1, DL2_{—}1, . . . , DLm_{—}1 and a plurality of second data lines DL1_{—}2, DL2_{—}2, . . . , DLm_{—}2. Each of the first data lines DL1_{—}1, DL2_{—}1, . . . , DLm_{—}1 and the second data lines DL12, DL2_{—}2, . . . , DLm_{—}2 is connected to the pixels arranged in the corresponding column. That is, the pixels PX11 to PXnm are connected to a corresponding first data line of the first data lines DL1_{—}1, DL2_{—}1, . . . , DLm_{—}1 and a corresponding second data line of the second data lines DL1_{—}2, DL2_{—}2, . . . , DLm_{—}2. In addition, the pixels PX11 to PXnm are connected to a corresponding gate line of the gate lines GL1 to GLn.

The first data lines DL1_{—}1, DL2_{—}1, . . . , DLm_{—}1 are connected to the first data driver 150 to receive first data voltages. The second data lines DL1_{—}2, DL2_{—}2, . . . , DLm_{—}2 are connected to the second data driver 160 to receive second data voltages.

The gate lines GL1 to GLn are connected to the first gate driver 130 and the second gate driver 140 respectively through both ends thereof to receive gate signals.

The timing controller 120 receives image signals RGB and control signals CS from an external source, e.g., a system board. Although not shown in FIG. 1, the control signals CS include a vertical synchronization signal, a horizontal synchronization signal, a main clock signal, and a data enable signal.

The timing controller 120 converts a data format of the image signals RGB to a data format appropriate to an interface between the timing controller 120 and the first and second data drivers 150 and 160. The timing controller 120 provides the converted image signals R′G′B′ to the first and second data drivers 150 and 160.

The timing controller 120 generates a first gate control signal GCS1, a second gate control signal GCS2, a first data control signal DCS1, and a second data control signal DCS2 in response to the control signals CS. The first gate control signal GCS1 and the second gate control signal CGS2 are used to control an operation timing of the first gate driver 130 and the second gate driver 140. The first data control signal DCS1 and the second data control signal DCS2 are used to control an operation timing of the first data driver 150 and the second data driver 160.

Although not shown in FIG. 1, each of the first and the second data signals DCS1 and DCS2 includes a latch signal, a horizontal start signal, a polarity control signal, and a clock signal. Each of the first and the second gate signals GCS1 and GCS2 includes a vertical start signal, a gate clock signal, and an output enable signal.

The timing controller 120 applies the first gate control signal GCS1 to the first gate driver 130 and applies the second gate control signal GCS2 to the second gate driver 140. In addition, the timing controller 120 applies the first data control signal DCS1 and the second data control signal DCS2 to the first data driver 150 and the second data driver 160, respectively.

The first and the second gate drivers 130 and 140 are respectively located at left and right sides of the display panel 110. The first gate driver 130 outputs the gate signals in response to the first gate control signal GCS1 from the timing controller 120. The second gate driver 140 outputs the gate signals in response to the second gate control signal GCS2 from the timing controller 120.

The first and the second gate drivers 130 and 140 sequentially apply the same gate signals to the gate lines GL1 to GLn, and thus the gate lines GL1 to GLn are operated in dual mode. The gate signals sequentially applied to the pixels PX11 to PXnm one row at a time. Even though, embodiments of the present invention is described using the dual mode operation, the present invention should not be limited to the dual mode operation.

The dual mode operation has some advantages as compared to a single mode operation. In a single driving method that one gate driver is applied to the display apparatus, the gate signals are applied to one end of the gate lines. In this case, a deviation of the gate signals occurs as the gate signals travel to closer to the other end of the gate lines due to the propagation delay of the gate signals. As a result, a time period required to charge the pixels with the data voltages due to the deviation of the gate signals. Consequently, a horizontal line is perceived by a viewer.

In case of a dual driving method, the same gate lines are applied to the gate lines GL1 to GLn through the both ends of the gate lines GL1 to GLn by two gate drivers as described above. The propagation delay of the gate signals does not occurs and the time period required is sufficient to charge the pixels PX11 to PXnm with the data voltages, thereby preventing the horizontal line from being perceived by the viewer.

The first gate driver 130 and the second gate driver 140 may be directly formed on the left and right side surfaces of the display panel 110 in an amorphous silicon TFT gate driver circuit (ASG). That is, the first and second gate drivers 130 and 140 may be formed on the display panel 110 through the same process as transistors of the pixels PX11 to PXnm.

The first data driver 150 and the second data driver 160 are mounted on the display panel 110. The first data driver 150 and the second data driver may be data driver ICs located adjacent to an upper portion and a lower portion of the display panel 110 to be connected to the upper portion and a lower portion of the display panel 110, respectively.

The first data driver 150 and the second data driver 160 convert the image signals R′G′B′ to the data voltages in response to the first and the second data control signals DCS1 and DCS2 from the timing controller 120, respectively. In detail, the first data driver 150 outputs first data voltages and the second data driver 160 outputs second data voltages.

The first data voltages are applied to the pixels PX11 to PXnm through the first data lines DL1_{—}1, DL2_{—}1, DLm_{—}1. The second data voltages are applied to the pixels PX11 to PXnm through the second data lines DL1_{—}2, DL2_{—}2, . . . , DLm_{—}2.

The pixels PX11 to PXnm of the display panel 110 receive a common voltage Vcom from a voltage generator (not shown). The common voltage Vcom has a constant voltage level. The first data voltages and the second data voltages may be changed according to gray scales to be displayed on the pixels PX11 to PXnm.

The first data voltages may be defined by a first absolute value of difference in voltage between the common voltage Vcom and the first data voltages from the first data driver 150. The second data voltages may be defined by a second absolute value of difference in voltage between the common voltage Vcom and the second data voltages from the second data driver 160.

The first data voltages have a different level from the second data voltages. For instance, the first data voltages have a voltage level required to display high gray scales and the second data voltages have a voltage level required to display low gray scales. That is, the first data voltages have the voltage level higher than the second data voltages.

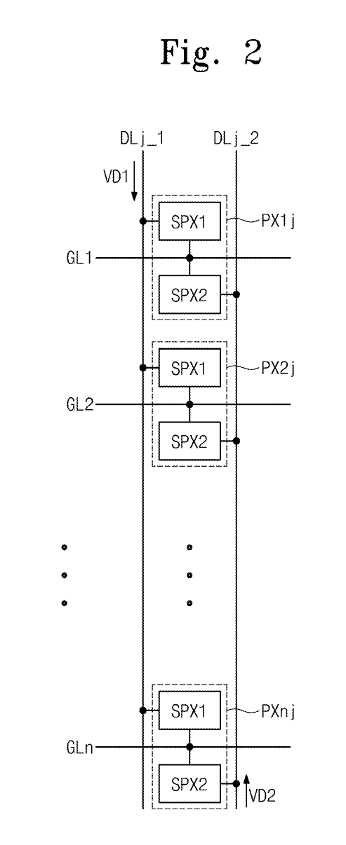

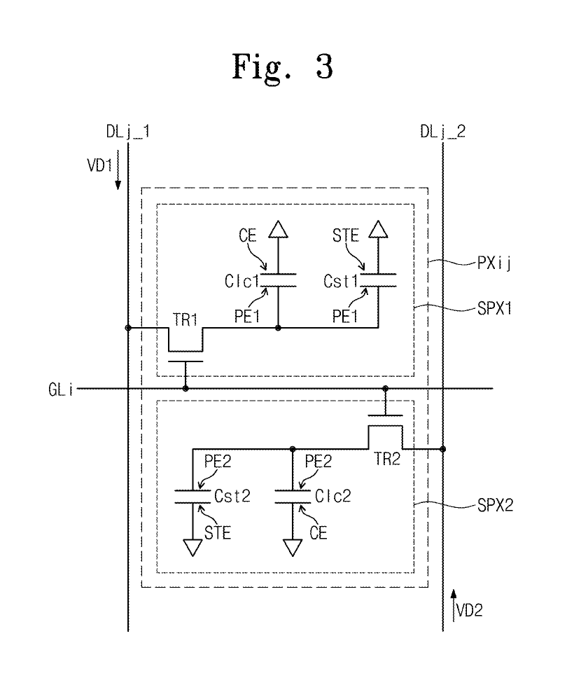

Each of the pixels PX11 to PXnm includes first and second sub-pixels (refer to FIGS. 2 and 3). The first and the second sub-pixels are charged with data voltages having different levels from each other. For example, the first sub-pixel receives the first data voltage and the second sub-pixel receives the second data voltage. In this case, the first sub-pixel is charged with a first pixel voltage corresponding to a first difference value and the second sub-pixel is charged with a second pixel voltage corresponding to a second difference value. Accordingly, the viewer may perceive the gray scale corresponding to an intermediate value between the first pixel voltage and the second pixel voltage.

Although not shown in FIG. 1, the display apparatus 100 includes a backlight unit to provide light to the display panel 110. The backlight unit includes a light source that generates the light, and the light source is configured to include a fluorescent lamp or a light emitting diode.

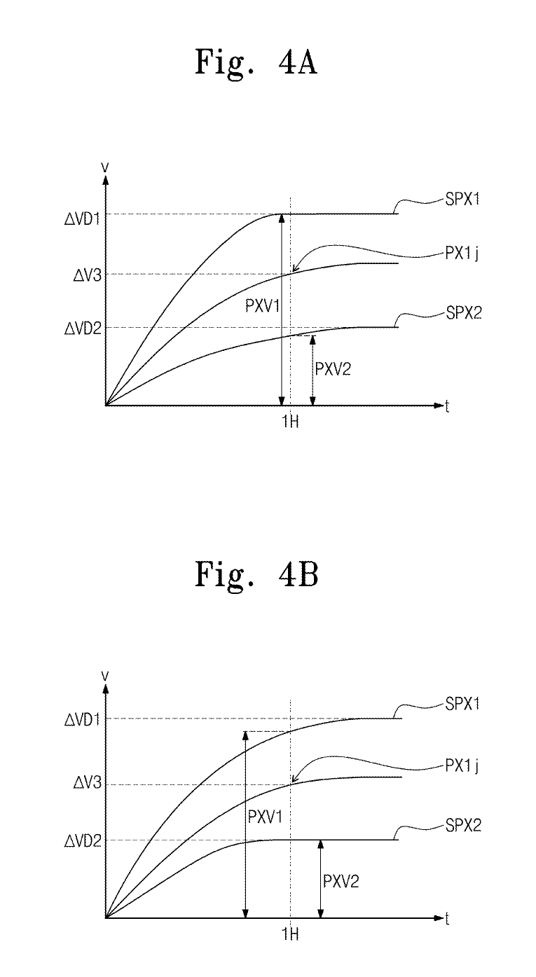

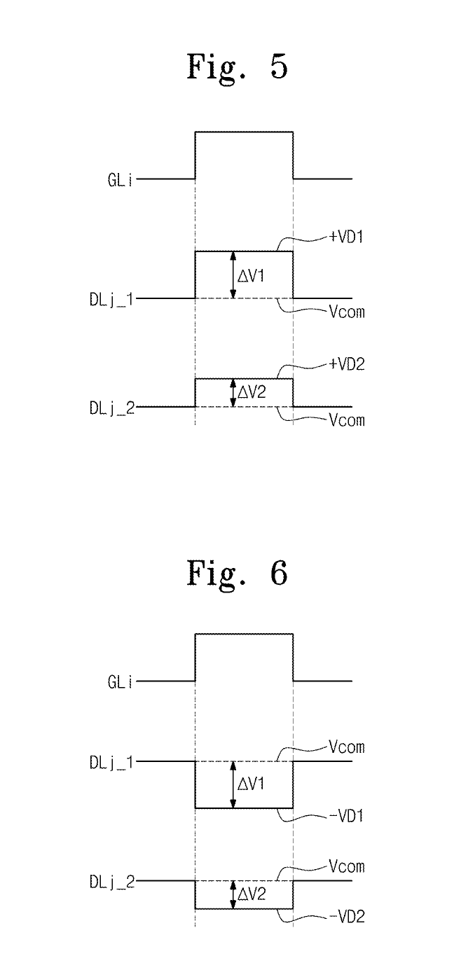

FIG. 2 is a view showing pixels arranged in arbitrary one column among pixels shown in FIG. 1 and FIG. 3 is an equivalent circuit diagram showing arbitrary one pixel shown in FIG. 1. FIG. 4A is a view showing charging voltages at a first pixel among pixels arranged in an arbitrary column shown FIG. 2. FIG. 4B is a view showing charging voltages at a last pixel among pixels arranged in an arbitrary column shown FIG. 2.

Hereinafter, the configuration and operation of the pixels arranged in arbitrary one column will be described in detail with reference to FIGS. 2, 3, 4A and 4B, but the pixels arranged in the other columns not shown have the same configuration and are operated in the same way.

Referring to FIGS. 2 and 3, each pixel PX1j to PXnj includes a first sub-pixel SPX1 and a second sub-pixel SPX2. The first sub-pixel SPX1 is connected to a corresponding first data line DLj_{—}1 and the second sub-pixel SPX2 is connected to a corresponding second data line DLj_{—}2. The first and the second sub-pixels SPX1 and SPX2 are commonly connected to a corresponding gate line of the gate lines GL1 to GLn.

For instance, according to the pixel PXij shown in FIG. 3, the first sub-pixel SPX1 is connected to the first data lines DLj_{—}1 and the second sub-pixel SPX2 is connected to the second data line DLj_{—}2. The first and second sub-pixels SPX1 and SPX2 are commonly connected to the gate line GLi. Here, “i” is an integer number larger than zero (0) and equal to or smaller than “n”, and “j” is an integer number larger than zero (0) and equal to or smaller than “m”.

The first data driver 150 applies the first data voltage VD1 to the first data line DLj_{—}1. The first sub-pixels SPX1 receive the first data voltage VD1 in response to the gate signals provided respectively through the gate lines GL1 to GLn. That is, the first data voltage VD1 is sequentially applied to the first sub-pixels SPX1 from the first sub-pixel SPX1 connected to an upper portion of the first data line DLj_{—}1.

The second data driver 160 applies the second data voltage VD2 to the second data line DLj_{—}2. The second sub-pixels SPX2 receive the second data voltage VD2 in response to the gate signals provided respectively through the gate lines GL1 to GLn. That is, the second data voltage VD2 is sequentially applied to the second sub-pixels SPX2 from the second sub-pixel SPX2 connected to a lower portion of the second data line DLj_{—}2.

As shown in FIG. 3, the first sub-pixel SPX1 includes a first transistor TR1, a first liquid crystal capacitor Clc1, and a first storage capacitor Cst1. The second sub-pixel SPX2 includes a second transistor TR2, a second liquid crystal capacitor Clc2, and a second storage capacitor Cst2.

The first transistor TR1 of the first sub-pixel SPX1 includes a source electrode connected to the first data line DLj_{—}1, a gate electrode connected to the gate line GLi, and a drain electrode connected to a first liquid crystal capacitor Clc1 and a first storage capacitor Cst1.

The first liquid crystal capacitor Clc1 includes a first pixel electrode PE1 connected to the drain electrode of the first transistor TR1, a common electrode CE applied with the common voltage Vcom and facing the first pixel electrode PE1, and a liquid crystal layer (not shown) interposed between the first pixel electrode PE1 and the common electrode CE. The first storage capacitor Cst1 includes the first pixel electrode PE1, a storage electrode STE applied with the common voltage Vcom, and an insulating layer (not shown) interposed between the first pixel electrode PE1 and the storage electrode STE.

The second transistor TR2 of the second sub-pixel SPX2 includes a source electrode connected to the second data line DLj_{—}2, a gate electrode connected to the gate line GLi, and a drain electrode connected to a second liquid crystal capacitor Clc2 and a second storage capacitor Cst2.

The second liquid crystal capacitor Clc2 includes a second pixel electrode PE2 connected to the drain electrode of the second transistor TR2, the common electrode CE applied with the common voltage Vcom and facing the second pixel electrode PE2, and the liquid crystal layer (not shown) interposed between the second pixel electrode PE2 and the common electrode CE. The second storage capacitor Cst2 includes the second pixel electrode PE2, the storage electrode STE applied with the common voltage Vcom, and the insulating layer (not shown) interposed between the second pixel electrode PE2 and the storage electrode STE.

The first transistor TR1 applies the first data voltage VD1 provided through the first data line DLj_{—}1 to the first liquid crystal capacitor Clc1 in response to the gate signal provided through the gate line GLi. The first data voltage VD1 is applied to the first liquid crystal capacitor Clc1. The first sub-pixel SPX1 is charged with a first pixel voltage by the first data voltage VD1. The first pixel voltage is referred to as voltage charged in the first sub-pixel SPX1.

The second transistor TR2 applies the second data voltage VD2 provided through the second data line DLj_{—}2 to the second liquid crystal capacitor Clc2 in response to the gate signal provided through the gate line GLi. The second data voltage VD2 is applied to the second liquid crystal capacitor Clc2. The second sub-pixel SPX2 is charged with a second pixel voltage by the second data voltage VD2. The second pixel voltage is referred to as voltage charged in the second sub-pixel SPX2.

The viewer perceives the gray scale corresponding to the intermediate value between the first pixel voltage and the second pixel voltage, which are charged in the pixel PXij.

Hereinafter, it is assumed that the first data voltage VD1 is greater than the second data voltage VD2.

In a case that there is no second data driver 160, the second data line DLj_{—}2 is connected to the first data driver 150 to receive the second data voltage. That is, the first data driver 150 applies the first data voltage VD1 and the second data voltage VD2 to the first and second sub-pixels SPX1 and SPX2, respectively, through the first data line DLj_{—}1 and the second data line DLj_{—}2. Therefore, the first and second data voltages VD1 and VD2 are applied to the first and the second sub-pixels SPX1 and SPX2 from the upper portion of the first and the second data lines DLj_{—}1 and DLj_{—}2.

Although not shown in FIG. 2, the first and the second data lines DLj_{—}1 and DLj_{—}2 have a resistance component. When the second data driver 160 is omitted, the first and the second data voltages VD1 and VD2 are applied to the first and the second sub-pixels SPX1 and SPX2 through the upper portions of the first and the second data lines DLj_{—}1 and DLj_{—}2. Accordingly, the propagation delay of the first and the second data voltages VD1 and VD2 at the first and the second data lines DLj_{—}1 and DLj_{—}2 is increased as they travel to closer to the lower portions of the first and the second data lines DLj_{—}1 and DLj_{—}2 due to the resistance component of the first and the second data lines DLj_{—}1 and DLj_{—}2. As a result, a deviation of the data voltage applied to the first and the second data lines DLj_{—}1 and DLj_{—}2 from the desired data voltage level occurs, so that the desired pixel voltage may not be charged in the first and the second sub-pixels SPX1 and SPX2.

For instance, when the first data voltage VD1, which has the first difference value of about 7 volts when compared to the common voltage Vcom, is applied to the first sub-pixels SPX1 and the second data voltage VD2, which has the second difference value of about 3 volts when compared to the common voltage Vcom, is applied to the second sub-pixels SPX2, the voltages respectively corresponding to the first and the second difference values, e.g., about 7 volts and about 3 volts, are applied to the first and the second sub-pixels SPX1 and SPX2 of the first pixel PX1j, respectively. Therefore, the first sub-pixel SPX1 of the first pixel PX1j is charged with the first pixel voltage corresponding to the voltage of about 7 volts and the second sub-pixel SPX2 of the first pixel PX1j is charged with the second pixel voltage corresponding to the voltage of about 3 volts. In this case, the viewer perceives the gray scale corresponding to the intermediate value, e.g., about 5 volts, between about 7 volts and about 3 volts.

The first and the second sub-pixels SPX1 and SPX2 of the last pixel PXnj are respectively applied with a voltage smaller than the first difference value and a voltage smaller than the second difference value due to the propagation delay of the data line. For instance, the first sub-pixel SPX1 of the last pixel PXnj is charged with the first pixel voltage of about 6 volts smaller than the first difference value and the second sub-pixel SPX2 of the last pixel PXnj is charged with the second pixel voltage of about 2 volts smaller than the second difference value. In this case, the viewer perceives the gray scale corresponding to the intermediate value, e.g., about 4 volts, between about 6 volts and about 2 volts. As a result, brightness difference occurs between the pixels PX1j and PXnj, and thus a vertical line is perceived by a viewer.

The first data driver 150 sequentially applies the first data voltage VD1 to the pixels PX1j to PXnj from the pixel PX1j disposed at the upper portion of the display panel 110 through the first data line DLj_{—}1. In addition, the second data driver 160 applies the second data voltage VD2 to the pixels PX1j to PXnj from the pixel PXnj disposed at the lower portion of the display panel 110 through the second data line DLj_{—}2.

As described above, the first and the second data lines DLj_{—}1 and DLj_{—}2 have the resistance component. The first data line DLj_{—}1 receives the first data voltage VD1 through the upper portion thereof. Thus, the propagation delay is increased as it goes to closer to the lower portion of the first data line DLj_{—}1 due to the resistance component. That is, the first data voltage VD1 is normally applied to the first sub-pixel SPX1 of the first pixel PX1j, but the first data voltage VD1 applied to the first sub-pixels SPX1 becomes abnormal as it goes to closer to the lower portion of the display panel 110.

The second data line DLj_{—}2 receives the second data voltage VD2 through the lower portion thereof. Thus, the propagation delay is increased as it goes to closer to the upper portion of the second data line DLj_{—}2 due to the resistance component. That is, the second data voltage VD2 is normally applied to the second sub-pixel SPX2 of the last pixel PXnj, but the second data voltage VD2 applied to the second sub-pixels SPX2 becomes abnormal as it goes to closer to the upper portion of the display panel 110.

Referring to FIGS. 4A and 4B, the first sub-pixel SPX1 of the first pixel PX1j is charged with the first pixel voltage PXV1 having the first difference value ΔVD1 corresponding to the first data voltage VD1 in an 1H period. The 1H period is referred to as high-level period of the gate signal. However, the first sub-pixel SPX1 of the last pixel PXnj is not charged with the first pixel voltage PXV1 having the first difference value ΔVD1 in the 1H period due to the propagation delay of the data line. That is, the first sub-pixel SPX1 of the last pixel PXnj is charged with the first pixel voltage PXV1 having a value lower than the first difference value ΔVD1 in the 1H period due to the propagation delay of the data line.

For instance, in the case that the first data voltage VD1 has the voltage level of about 7 volts, the first sub-pixel SPX1 of the first pixel PX1j is charged with the first pixel voltage corresponding to about 7 volts. However, the first sub-pixel SPX1 of the last pixel PXnj is charged with the first pixel voltage corresponding to about 6 volts due to the propagation delay of the data line.

The second sub-pixel SPX2 of the last pixel PXnj is charged with the second pixel voltage PXV2 having the second difference value ΔVD2 corresponding to the second data voltage VD2 in the 1H period. However, the second sub-pixel SPX2 of the first pixel PX1j is not charged with the second pixel voltage PXV2 having the second difference value ΔVD2 in the 1H period due to the propagation delay of the data line. That is, the second sub-pixel SPX2 of the first pixel PX1j is charged with the second pixel voltage PXV2 having a value lower than the second difference value ΔVD2 in the 1H period due to the propagation delay of the data line.

For instance, in the case that the second data voltage VD2 has the voltage level of about 3 volts, the second sub-pixel SPX2 of the last pixel PXnj is charged with the second pixel voltage corresponding to about 3 volts. However, the second sub-pixel SPX2 of the first pixel PX1j is charged with the second pixel voltage corresponding to about 2 volts due to the propagation delay of the data line.

As shown in FIG. 4A, the first pixel PX1j provides the viewer with the gray scales corresponding to the intermediate value ΔVD3 of between the first pixel voltage PXV1 charged in the first sub-pixel SPX1 of the first pixel PX1j and the second pixel voltage PXV2 charged in the second sub-pixel SPX2 of the first pixel PX1j. Also, As shown in FIG. 4B, the last pixel PXnj provides the viewer with the gray scales corresponding to the intermediate value ΔVD3 of between the first pixel voltage PXV1 charged in the first sub-pixel SPX1 of the last pixel PXnj and the second pixel voltage PXV2 charged in the second sub-pixel SPX2 of the last pixel PXnj.

For instance, the first sub-pixel SPX1 of the first pixel PX1j is charged with the first pixel voltage PXV1 of about 7 volts and the second sub-pixel SPX2 of the first pixel PX1j is charged with the second pixel voltage PXV2 of about 2 volts due to the propagation delay of the data line. Accordingly, the viewer may perceive the gray scale corresponding to the intermediate value ΔVD3 of about 4.5 volts between the first pixel voltage PXV1 and the second pixel voltage PXV2, which are respectively charged in the first and second sub-pixels SPX1 and SPX2 of the first pixel PX1j.

In addition, the first sub-pixel SPX1 of the last pixel PXnj is charged with the first pixel voltage PXV1 of about 6 volts due to the propagation delay of the data line and the second sub-pixel SPX2 of the last pixel PXnj is charged with the second pixel voltage PXV2 of about 3 volts. Accordingly, the viewer may perceive the gray scale corresponding to the intermediate value ΔVD3 of about 4.5 volts between the first pixel voltage PXV1 and the second pixel voltage PXV2, which are respectively charged in the first and second sub-pixels SPX1 and SPX2 of the last pixel PXnj.

Thus, the viewer may perceive the gray scales corresponding to the intermediate value ΔVD3 of about 4.5 volts in the first and last pixels PX1j and PXnj. That is, the first and second pixel voltages PXV1, PXV2 charged in the first and last pixels PX1j and PXnj are complementary to one another, so that the gray scales corresponding to the same intermediate value are perceived by the viewer.

In the present exemplary embodiment, the first and last pixels PX1j and PXnj have been described as an example, but the first and the second pixel voltages PXV1, PXV2 may be complementary to one another in the other pixels. Accordingly, the gray scales corresponding to the same intermediate value may be perceived by the viewer. In other words, since the brightness difference between the pixels PX1j and Pxnj is reduced, the vertical line may be prevented from being perceived.

Consequently, the display apparatus 100 reduces the brightness difference between the pixels PX11 to PXnm, thereby preventing occurrence of the vertical line.

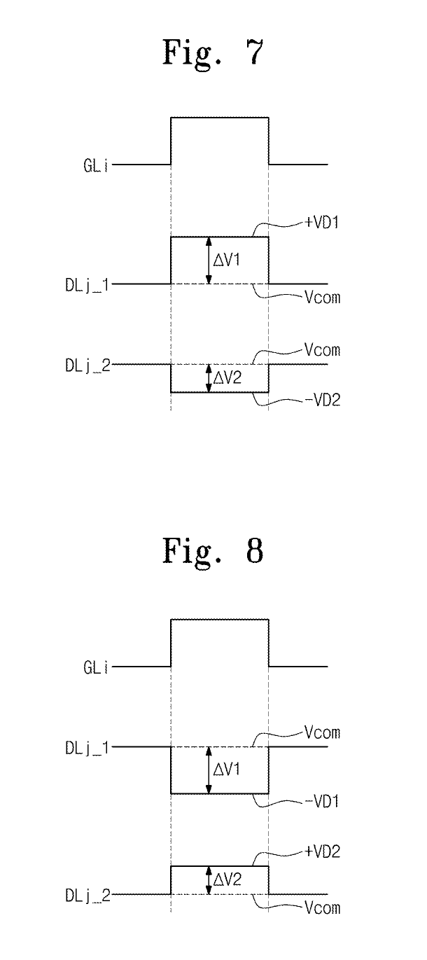

FIGS. 5 to 8 are waveform diagrams showing polarities of first and second data voltages applied to the pixel shown in FIG. 3.

Hereinafter, the data voltage having a level higher than that of the common voltage Vcom is referred to as a positive (+) data voltage and the data voltage having a level lower than that of the common voltage Vcom is referred to as a negative (−) data voltage.

Referring to FIG. 5, the positive (+) first data voltage +VD1 is applied to the first sub-pixel SPX1 through the first data line DLj_{—}1 and the positive (+) second data voltage +VD2 is applied to the second sub-pixel SPX2 through the second data line DLj_{—}2. The positive (+) first data voltage +VD1 has the first difference value ΔV1 and the positive (+) second data voltage +VD2 has the second difference value ΔV2. The first difference value ΔV1 is greater than the second difference value ΔV2.

Referring to FIG. 6, the negative (−) first data voltage −VD1 is applied to the first sub-pixel SPX1 through the first data line DLj_{—}1 and the negative (−) second data voltage −VD2 is applied to the second sub-pixel SPX2 through the second data line DLj_{—}2. The negative (−) first data voltage −VD1 has the first difference value ΔV1 and the negative (−) second data voltage −VD2 has the second difference value ΔV2. The first difference value ΔV1 is greater than the second difference value ΔV2.

Referring to FIG. 7, the positive (+) first data voltage +VD1 is applied to the first sub-pixel SPX1 through the first data line DLj_{—}1 and the negative (−) second data voltage −VD2 is applied to the second sub-pixel SPX2 through the second data line DLj_{—}2. The positive (+) first data voltage +VD1 has the first difference value ΔV1 and the negative (−) second data voltage −VD2 has the second difference value ΔV2. The first difference value ΔV1 is greater than the second difference value ΔV2.

Referring to FIG. 8, the negative (−) first data voltage −VD1 is applied to the first sub-pixel SPX1 through the first data line DLj_{—}1 and the positive (+) second data voltage +VD2 is applied to the second sub-pixel SPX2 through the second data line DLj_{—}2. The negative (−) first data voltage −VD1 has the first difference value ΔV1 and the positive (+) second data voltage +VD2 has the second difference value ΔV2. The first difference value ΔV1 is greater than the second difference value ΔV2.

Consequently, each of the first data voltage VD1 and the second data voltage VD2 may have the positive (+) polarity and the negative (−) polarity. The first data voltage VD1 and the second data voltage VD2 applied to the pixels PX11 to PXnm may have the same polarity or different polarities.

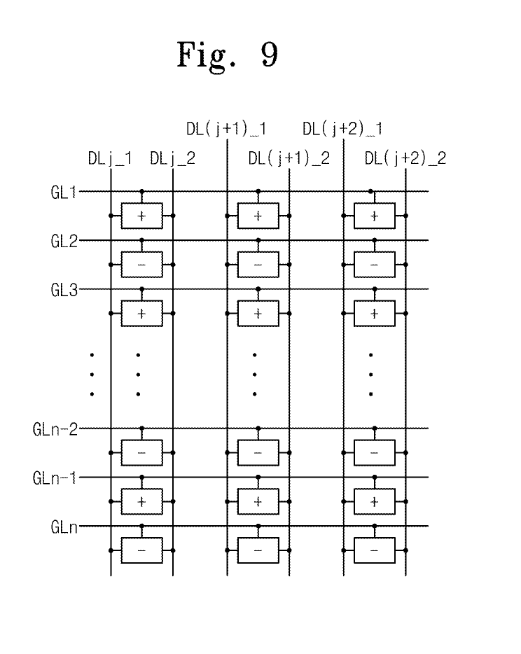

FIG. 9 is a view showing driving states of pixels. For the convenience of explanation, FIG. 9 shows the pixels arranged in three columns, but the pixels arranged in other columns may be operated in the same way as the pixels arranged in the three columns.

Referring to FIG. 9, the pixels are operated such that a polarity of each pixel is inverted at every row. That is, the pixels are operated by a line inversion drive scheme. For the line inversion drive scheme, the positive (+) first and the positive (+) second data voltages +VD1 and +VD2 are alternately applied to the data lines with the negative (−) first and the negative (−) second data voltages −VD1 and −VD2 in the column direction.

For instance, the pixels connected to odd-numbered gate lines GL1, GL3, . . . , GLn-1 receive the positive (+) first and the positive (+) second data voltages +VD1 and +VD2 through the data lines DLj_{—}1, DLj_{—}2, DL(j+1)_{—}1, DL(j+1)_{—}2, DL(j+2)_{—}1, and DL(j+2)_{—}2. Accordingly, the pixels connected to the odd-numbered gate lines GL1, GL3, . . . , GLn-1 have the positive (+) polarity.

The pixels connected to even-numbered gate lines GL2, GL4, . . . , GLn receive the negative (−) first and the negative (−) second data voltages −VD1 and −VD2 through the data lines DLj_{—}1, DLj_{—}2, DL(j+1)_{—}1, DL(j+1)2, DL(j+2)_{—}1, and DL(j+2)_{—}2. Accordingly, the pixels connected to the even-numbered gate lines GL2, GL4, . . . , GLn have the negative (−) polarity.

In FIG. 9, the polarity of the pixels is inverted at every row, but the operation of the pixels should not be limited thereto or thereby. That is, the pixels may be operated such that the polarity of the pixels is inverted at every column or at every row and column, e.g., a dot inversion drive scheme. In case of the dot inversion drive scheme, the positive (+) first and the positive (+) second data voltages +VD1 and +VD2 are alternately applied to the data lines with the negative (−) first and the negative (−) second data voltages −VD1 and −VD2 in the column and row directions.

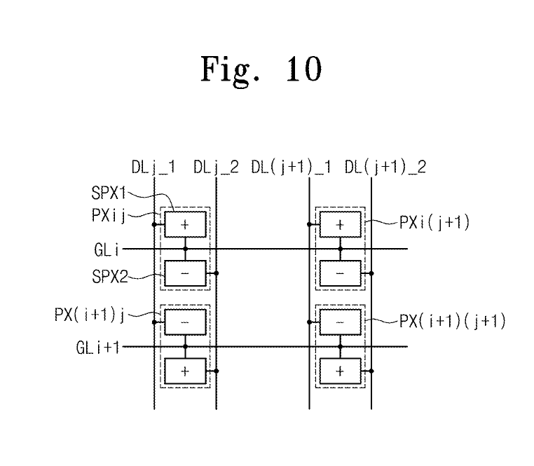

FIG. 10 is a view showing driving states of sub-pixels. For the convenience of explanation, FIG. 10 shows the first and second sub-pixels of each of four pixels, but the other pixels may be operated in the same way as the four pixels.

Referring to FIG. 10, the first and the second sub-pixels SPX1 and SPX2 of the pixels PXij, PXi(j+1), PX(i+1)j, and PX(i+1)(j+1) are operated to have different polarities from each other. The first sub-pixels SPX1 of the pixels PXij, PXi(j+1), PX(i+1)j, and PX(i+1)(j+1) are operated to allow the polarity of the first sub-pixels SPX1 to be inverted at every row, and the second sub-pixels SPX2 of the pixels PXij, PXi(j+1), PX(i+1)j, and PX(i+1)(j+1) are operated such that the polarity of the second sub-pixels SPX2 is inverted at every row.

For instance, the first sub-pixels SPX1 of the pixels PXij and PXi(j+1) connected to an i-th gate line GLi are applied with the positive (+) first data voltage +VD1 through the first data lines DLj_{—}1 and DL(j+1)_{—}1. Accordingly, the first sub-pixels SPX1 of the pixels PXij and PXi(j+1) connected to the i-th gate line GLi have the positive (+) polarity.

The first sub-pixels SPX1 of the pixels PX(i+1)j and PX(i+1)(j+1) connected to an (i+1)th gate line GLi+1 are applied with the negative (−) first data voltage −VD1 through the first data lines DLj_{—}1 and DL(j+1)_{—}1. Accordingly, the first sub-pixels SPX1 of the pixels PX(i+1)j and PX(i+1)(j+1) connected to the (i+1)th gate line GLi+1 have the negative (−) polarity.

The second sub-pixels SPX2 of the pixels PXij and PXi(j+1) connected to the i-th gate line GLi are applied with the negative (−) second data voltage −VD2 through the second data lines DLj_{—}2 and DL(j+1)_{—}2. Accordingly, the second sub-pixels SPX2 of the pixels PXij and PXi(j+1) connected to the i-th gate line GLi have the negative (−) polarity.

The second sub-pixels SPX2 of the pixels PX(i+1)j and PX(i+1)(j+1) connected to the (i+1)th gate line GLi+1 are applied with the positive (+) second data voltage +VD2 through the second data lines DLj_{—}2 and DL(j+1)_{—}2. Accordingly, the second sub-pixels SPX2 of the pixels PX(i+1)j and PX(i+1)(j+1) connected to the (i+1)th gate line GLi+1 have the positive (−) polarity.

Consequently, the positive (+) first data voltage +VD1 and the negative (−) first data voltage −VD1 are alternately applied to the first sub-pixels SPX1 of the pixels PX11 to PXnm one row at a time. In addition, the negative (−) second data voltage −VD2 and the positive (+) second data voltage +VD2 are alternately applied to the second sub-pixels SPX2 of the pixels PX11 to PXnm one row at a time.

In FIG. 10, the first and the second sub-pixels have different polarities from each other and the polarities of the first and the second sub-pixels are inverted at every row, but the operation of the pixels should not be limited thereto or thereby. That is, the polarities of the first and the second sub-pixels, which have the different polarities from each other, may be inverted in the unit of column.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel that includes a plurality of pixels arranged in a matrix form, each of the plurality of pixels including a high pixel and a low pixel having a gray level lower than that of the high pixel;
a first data driver disposed on a first side of the display panel and applying first data voltages to the high pixels through first data lines;
a second data driver disposed on a second side opposite to the first side of the display panel and applying second data voltages to the low pixels through second data lines; and
a first gate driver formed on a third side of the display panel between the first side and the second side, and sequentially applying gate signals to the plurality of pixels connected to gate lines,
wherein the first data voltages are sequentially supplied to the high pixels from the first side of the display panel and the second data voltages are sequentially supplied to the low pixels from the second side of the display panel opposite to the first side.

2. The display apparatus of claim 1, wherein each of the pixels receives a common voltage, a first data voltage having a level corresponding to a first difference value defined by an absolute value of a level difference between the first data voltage and the common voltage and a second data voltage having a level corresponding to a second difference value defined by an absolute value of a level difference between the second data voltage and the common voltage.

3. The display apparatus of claim 2, wherein the first difference value is greater than the second difference value.

4. The display apparatus of claim 2, wherein the high pixel is charged with a first pixel voltage corresponding to the first difference value and the low pixel is charged with a second pixel voltage corresponding to the second difference value.

5. The display apparatus of claim 2, wherein the high pixel comprises:
a first transistor connected to a corresponding gate line and a corresponding first data line; and
a first liquid crystal capacitor connected to the first transistor, the first transistor applying a corresponding first data voltage provided through the corresponding first data line to the first liquid crystal capacitor in response to a corresponding gate signal provided through the corresponding gate line.

6. The display apparatus of claim 2, wherein the low pixel comprises:
a second transistor connected to the corresponding gate line and a corresponding second data line; and
a second liquid crystal capacitor connected to the second transistor, the second transistor applying a corresponding second data voltage provided through the corresponding second data line to the second liquid crystal capacitor in response to the corresponding gate signal provided through the corresponding gate line.

7. The display apparatus of claim 2, wherein each of the first data voltage and the second data voltage has a positive or negative polarity.

8. The display apparatus of claim 7, wherein the high pixel and the low pixel of any one of the pixels are applied with the first data voltage having the positive polarity and the second data voltage having the positive polarity, respectively.

9. The display apparatus of claim 8, wherein the high pixel and the low pixel of another one of the pixels are applied with the first data voltage having the negative polarity and the second data voltage having the negative polarity, respectively.

10. The display apparatus of claim 9, wherein the first and second data voltages having the positive polarity and the first and second data voltages having the negative polarity are alternately applied to the pixels in a column direction.

11. The display apparatus of claim 9, wherein the first and second data voltages having the positive polarity and the first and second data voltages having the negative polarity are alternately applied to the pixels in a column direction and a row direction.

12. The display apparatus of claim 7, wherein the high pixel and the low pixel are applied with the first and second data voltages having different polarities from each other.

13. The display apparatus of claim 12, wherein the high pixel of any one of the pixels receives the first data voltage having the positive polarity and the low pixel of the any one of the pixels receives the second data voltage having the negative polarity.

14. The display apparatus of claim 13, wherein the high pixel of another one of the pixels receives the first data voltage having the negative polarity and the low pixel of the another one of the pixels receives the second data voltage having the positive polarity.

15. The display apparatus of claim 14, wherein the first data voltage having the positive polarity and the first data voltage having the negative polarity are alternately and repeatedly applied to the high pixels of the pixels at every row, and the second data voltage having the negative polarity and the second data voltage having the positive polarity are alternately and repeatedly applied to the low pixels of the pixels at every row.

16. The display apparatus of claim 1, wherein the first data driver is located at a position adjacent to an upper portion of the display panel and the second data driver is located at a position adjacent to a lower portion of the display panel.

17. The display apparatus of claim 1, further comprising a second gate driver formed on a fourth side opposite the third side of the display panel and sequentially applying the gate signals to the plurality of pixels connected to the gate lines.

18. The display apparatus of claim 17, wherein the first and second gate drivers are respectively mounted on left and right sides in an amorphous silicon TFT gate driver circuit (ASG).
